(19) United States
(12) Patent Application Publication
(10) Pub. No.: US 2023/0288307 A1
(43) Pub. Date: Sep. 14, 2023

(54) INTERFEROMETRIC SCATTERING CORRELATION (ISCORR) MICROSCOPY

(71) Applicant: Cambridge Enterprise Limited, Cambridge (GB)

(72) Inventors: Quentin Alexis Peter, Cambridge (GB); Raphaël Jacquat, Cambridge (GB); Georg Krainer, Cambridge (GB); Tuomas Pertti Jonathan Knowles, Cambridge (GB)

(73) Assignee: Cambridge Enterprise Limited, Cambridge (GB)

(21) Appl. No.: 18/014,701

(22) PCT Filed: Jul. 2, 2021
(86) PCT No.: PCT/EP2021/068359

§ 371 Date: Jan. 5, 2023

(30) Foreign Application Priority Data
Jul. 7, 2020 (GB) 2010411.3

(51) Int. Cl. G01N 15/02; G02B 21/36; G02B 21/08; G03H 1/00; G03H 1/04

(52) U.S. Cl. CPC G01N 15/0227; G02B 21/367; G02B 21/08; G03H 1/0005; G03H 1/0443; G03H 2001/005; G03H 2001/0445; G03H 2222/45; G03H 2210/62; G03H 2210/56

(57) ABSTRACT

A method of characterizing one or more particles in a fluid, e.g. a liquid, using interferometric scattering optical (iSCAT) microscopy. The method involves illuminating a region of a fluid using an objective lens so that light is scattered by one or more particles in the fluid. The scattered light and reference light are captured using the objective lens and interfere at an imaging device. A succession of images of the interference is processed to determine image correlation values which define a gradual decorrelation over time from which a property of the particle(s) is determined.

### FIELD

This specification relates to characterizing particles using interferometric scattering optical microscopy.

The work leading to this invention has received funding from the European Research Council under the European Union's Seventh Framework Programme (FP7/2007-2013)/ERC grant agreement no 337969. The project leading to this application has received funding from the European Union's Horizon 2020 research and innovation programme under the Marie Sklodowska-Curie grant agreement No 841466.

### BACKGROUND

Interferometric scattering optical microscopy (iSCAT) is a technique in which an imaged particle is illuminated with coherent e.g. laser light and the signal results from interference between light scattered from the particle and a reference, typically light reflected from a nearby interface. This interference can result in signals which are amplified compared with some other approaches and the technique is capable of label-free detection of even single molecules, such as biological molecules for example proteins/protein complexes.

In more detail, the iSCAT signal can be separated into three components, the reference e.g. reflected laser light, the scattered light, and the interference between the two. The reference laser light is dominant but does not carry any information, the scattered light is too weak to detect, and only the interference signal is useful.

A review of iSCAT can be found in Taylor et al. “Interferometric Scattering Microscopy: Seeing Single Nanoparticles and Molecules via Rayleigh Scattering”, Nano Letters 2019 19 (8), 4827-4835. Further background prior art can be found in: GB2552195; US2019/0195776; WO2019/110977; WO2015/059682; WO2018/189187; WO2018/047239; US2012/218629; WO2020/104814; and US2017/0248518.

One way to characterize particles using iSCAT would be to track the particles, but the interference signal can be small and tracking is hard: moving only a quarter wavelength in the depth-direction (z) can effectively make a particle disappear as the interference changes from constructive to destructive. One approach to this problem is to confine the particles in the depth direction and/or to use particle tracking techniques, but this is difficult in practice. iSCAT is typically performed on particles immobilized on a surface to stop the phase of the interference signal varying.

### SUMMARY

In one aspect there is therefore described a method of characterizing one or more particles in a fluid e.g. a liquid using interferometric scattering optical (iSCAT) microscopy. The method may comprise illuminating a region of a fluid, in particular a liquid, with illuminating light using an objective lens to generate scattered light scattered by one or more particles in the fluid, and providing reference light. In implementations the reference light and illuminating light are coherent with one another.

The method may further comprise capturing the reference light and the scattered light using the objective lens, and providing the reflected light and the scattered light to an imaging device, such that the reflected light and the scattered light interfere at the imaging device. The method may further comprise capturing a succession of images of the interference, and processing the succession of images of the interference to determine a succession of image correlation values. The succession of image correlation values may define a (gradual) decorrelation over time of, i.e. between, the captured images of the interference. The method may further comprise determining a property of the one or more particles from the succession of image correlation values defining the decorrelation over time.

The reference light may be provided by reflection from an interface. For example providing the reference light may comprise illuminating the region of the fluid through an interface, e.g. a boundary of the illuminated region, such that light is reflected from the interface to provide the reference light. Also or instead the reference light may be provided in some other way e.g. by using a portion of the illuminating light, or a source coherent with the illuminating light, as the reference. For example the illuminating light may comprise laser light and the laser light may be split into two (before or after the illuminated fluid) to generate the reference light.

In a still further arrangement excitation laser light impinges on the one or more particles from a first side of a sample of the fluid, and an optical system on a second, e.g. opposite, side of the sample collects the scattered light and the reference light i.e. the excitation laser light (which may be filtered to reduce its intensity, e.g. with a Fourier spatial filter). In such an arrangement no interface or reflection is needed (and later references to a region above a focal plane of the objective lens apply instead to a region below the focal plane).

In implementations an individual captured image may resemble noise, but by processing multiple images the correlation process is able to extract a decorrelation signal from the noise, and this can then be processed to characterize the one or more particles. This avoids the need to keep track of individual particles. Moreover the technique is able to process images in which particles are indistinguishable from noise in a single frame, where particle tracking is not possible. Thus implementations of the method are able to use iSCAT to characterize single particles, even when not apparent in the captured images. The particles may be or comprise molecules in aqueous solution, in particular biological molecules such as proteins. Further examples are given later.

The decorrelation over time may be used to determine one or more of a range of properties of the particles including their size, and/or shape, and/or number, and/or molecular weight, and/or interaction with the fluid e.g. liquid. Such a property may be determined by fitting a corresponding decorrelation function to the succession of image correlation values.

In some implementations a physical size of the one or more particles is determined; the determined size may be a hydrodynamic radius (or average radius) of the one or more particles. This may be determined by fitting a decorrelation function which is dependent upon a diffusion coefficient for the one or more particles in the fluid e.g. liquid, where the diffusion coefficient depends on the (average) hydrodynamic radius.

The interface may define a boundary of the fluid e.g. the boundary of a microfluidic channel or chamber, or the boundary of a surface on which the liquid lies.

In some implementations a focal plane of the objective lens is located above the interface and the decorrelation function is substantially independent of a distance of the one or more particles from the focal plane in a direction along an optical axis of the objective lens, that is the z-direction. This can facilitate fitting the decorrelation function to the succession of image correlation values, and hence facilitates particle size determination.

The intensity of the scattered light may be used to determine particle concentration and/or a molecular weight for the one or more particles (or a total molecule weight of particles in the field of view), as the scattered light intensity depends on both of these.

Above the focal plane an intensity of the scattered light (and a pattern of the interference) depends strongly on the position of a particle in the z-direction i.e. on the distance of the one or more particles from the focal plane in the z-direction. In this region determination of particle concentration or molecular weight may have reduced accuracy. Nonetheless accuracy may be recovered by integrating over the z-direction e.g. by integrating over time such that the decorrelation is measured over a period long enough for a single particle to diffuse over the z-direction. For example this may comprise integrating over a sufficient time period for the one or more particles, on average, to diffuse a distance in the z-direction of at least a depth of field of the objective lens, or to diffuse a distance of at least half the distance between the interface and the focal plane. This dependency can also be integrated out if there is more than one particle e.g. several particles, randomly distributed in the z-direction.

In some other implementations the focal plane of the objective lens is located adjacent to or below the interface. By locating the focal plane below or at the interface the particles may be confined to the region above the focal plane. The decorrelation function may then comprise an average (of a decorrelation) over at least a region beyond the interface i.e. over a region extending in the z-direction further from the interface than the focal plane. In implementations the averaging may extend over this region a distance at least sufficiently to encompass a field of view of the imaging device in the z-direction. Optionally the decorrelation function may also be averaged over a region between the focal plane and the interface.

In implementations fitting the decorrelation function comprises identifying which of one or more basis functions best fits the succession of image correlation values. Each of the basis functions may be defined by the size of the one or more particles and may be integrated over a region further from the interface than the focal plane, e.g. a region beyond the interface, and optionally over a region between the interface and the focal plane. The precise mathematical form of the function integrated to determine a basis function may depend on what is being modelled, e.g. diffusion and particle hydrodynamic size, particle shape/orientation, and so forth.

Locating the focal plane of the objective lens above the interface places the focal plane in the bulk of the fluid, away from the interface. This effectively puts the interface out of focus, reducing the effect of scattering from the interface and increasing image contrast. Also, particularly when operating in this regime the intensity of the scattered light (later |s|²) may be used to accurately determine particle concentration, or a count of the number of particles “visible” in the particle detection region, in particular by fitting the decorrelation function (i.e. basis functions).

In implementations of the method using interferometric scattering to determine the image correlation values results in the image correlation values including a noise term representing a noise variance in the signal from the captured images (which primarily arises from the reference light). Thus fitting the decorrelation function to the succession of image correlation values may include fitting an offset representing the noise level. Fitting the decorrelation function may also include fitting an additional function representing a systematic behavior or drift of the microscopy technique, e.g. a linear additional function; and/or a background correlation may be subtracted from the succession of image correlation values.

The interference pattern generated by a particle may comprise a set of concentric rings (visible when the particle is large enough for the pattern to be clearly visible). However if the particle moves by λ/4 in the z-direction, in particular when the particle is above the focal plane of the objective lens, the path length changes by twice this—more particularly, the interfering light changes in relative phase by π—and the rings move inwards or outwards so that e.g. a central bright spot becomes a dark spot i.e. the interference pattern is inverted so that bright becomes dark, and vice-versa. During the correlation two frames may be combined by subtraction and the interference signal can take positive and negative values, so diffusion in the z-direction can result in an average zero signal. More generally diffusion in the z-direction can strongly suppress the interference signal if the frame rate is low. To mitigate this, the succession of images of the interference may be captured at a frame rate (or effective frame rate as discussed below) greater than a threshold frame rate. The threshold frame rate may be such that, on average, a particle does not diffuse in a z-direction by more than λ/4 between captured images, where is a wavelength of the coherent light and the z-direction is defined by an optical axis of the objective lens. That is, the threshold frame rate may correspond to an inverse of the (de)correlation time (which may be defined by a decay constant for the correlation). Counter-intuitively, the signal decreases approximately according to the square root of the exposure time, as does the noise, and thus a longer exposure per se may not be beneficial.

The iSCAT signal depends on a product of the reflected and scattered light intensities. Whilst the reflected light intensity may be relatively constant, it is nonetheless useful to be able to separate the reflected and scattered light intensities, for example so that the scattered light intensity can be more easily used to estimate a number or concentration of particles present. This can be achieved by determining a square root of an intensity of the images of the interference before determining the succession of image correlation values. This approximately separates the reflected and scattered light intensities into separate terms, and the reflected light intensity term then drops from the correlation.

Noise in the image correlation values derived from interference images depends linearly on the intensity but varies as the square root of a number of image frames used to determine the image correlation values. Thus when collecting images for a particular effective image frame rate it can be beneficial to use a higher frame rate, with a consequently reduced intensity signal, and then combine or integrate multiple frames. However images combined in that way should not result in a total integration time longer than the (de)correlation time. Thus in some implementations processing the succession of images of the interference may include combining (integrating) images of the interference before determining the succession of image correlation values, provided that the combined images are separated in time by no more than a characteristic time of the decorrelation e.g. a time constant of correlation described by an exponential decay.

The image correlation values may in general be determined from a real-space representation of the captured images, or from a frequency-space representation of the captured images since (providing phase is preserved) these two representations are equivalent. There are many ways of determining an image correlation value representing the correlation between two images, For example in either real-space or frequency-space an image correlation value may be determined by summing a pixel-by-pixel comparison e.g. subtraction, of the two images. The succession of image correlation values may be determined by correlating an initial image with second images chosen at successively larger time intervals. However calculated the succession of image correlation values effectively defines the interference pattern decorrelation over time.

In some implementations differences between the images may determined in real space; this can assist in attenuating a bright reflected spot which may be present in a central part of the images.

In some implementations a space-frequency transform, e.g. a Fourier transform, may be performed to transform each of the images to a frequency (Fourier) space image before determining the succession of image correlation values.

For example each frequency space image may be spatially filtered to attenuate spatial frequencies greater than a maximum expected spatial frequency. This may involve masking a region of the frequency space image outside a central area e.g. circle of the frequency space image. For example in a real space image it may be expected that there are no features spaced closer than λ/4, and the frequency space images may be spatially filtered accordingly to attenuate higher frequency noise.

After such processing the frequency space images may be transformed back to real space, or the image correlation values may be determined from the frequency space images

In some implementations the frequency space images may be used to compensate for an overall translation of the particles when the fluid e.g. liquid is flowing. This is based on the recognition that translation of an interference pattern results in just a change in phase in frequency (Fourier) space.

Thus the method may include estimating a flow rate measure of the fluid e.g. liquid, e.g. an average phase, θ, in frequency space, from a succession of the frequency space images. The flow rate measure may then be used to compensate for a flow of the fluid, for example by compensating a frequency space image, or value e.g. difference derived therefrom, for the average phase, and hence the translation, when determining an image correlation value using that frequency space image or value.

Thus estimating the flow rate measure may comprise determining a ratio of two of the frequency space images (e.g. per pixel), where the ratio defines the phase angle θ. Compensating for the flow of the fluid may then comprise adjusting a phase angle of one or more of the frequency space images. For example, a difference between two successive frequency space (Fourier) images includes a phase term from the translation (fluid flow) and a scattering term from the change in interference (decorrelation). If the scattering term changes much less than phase term, e.g. because the images are closely spaced in time, then taking a ratio of these differences can approximately cancel the scattering term to extract the phase term. The difference between two frames comprises a translation term and a diffusion term, but the former can be assumed to be constant whilst the latter is random. Thus by averaging the ratio the diffusion term may be reduced towards zero leaving the translation term.

Again, the frequency space images may be transformed back to real space, with a correction to compensate for translation between images due to the fluid flow, and the image correlation values may be determined from the real space images; or the image correlation values may be determined from the frequency space images.

In some implementations an optical path of the coherent light to the objective lens is offset from the optical axis of the objective lens such that the coherent light illuminating the particle is at an oblique angle to the interface. However the reflected and scattered light may be captured in a direction along the optical axis of the objective lens. This can improve the contrast of the images of the interference, and also their signal-to-noise ratio.

In a related aspect there is described an interferometric scattering optical microscope system for characterizing one or more particles in a fluid e.g. a liquid. The system may comprise a particle detection region; this may have a boundary defined by an interface. In use, the particle detection region includes one or more particles in a fluid e.g. a liquid.

The system may include a source of illuminating e.g. coherent light, and a source of reference light. The reference light and illuminating light may be coherent with one another. The system may further include an objective lens to direct the illuminating light to illuminate the particle detection region such that the illuminating light is scattered by the one or more particles. The objective lens may be configured to capture the reference light and the scattered light.

The system may further comprise an imaging device, and may include an optical system to provide the reference light and the scattered light to the imaging device such that the reference light and the scattered light interfere at the imaging device.

The system may also include a processor configured to capture a succession of images of the interference. The processor may also process the succession of images of the interference to determine a succession of image correlation values. The succession of image correlation values may define a decorrelation over time of the captured images of the interference. The processor may also determine a property of the one or more particles from the succession of image correlation values defining the decorrelation over time.

The particle detection region may have a boundary defined by an interface, which serves as the source of reference light. More particularly the objective lens may be configured to direct the illuminating light to illuminate the particle detection region through the interface such that the illuminating light is reflected from the interface to generate the reference light.

The source of coherent light may be e.g. a source of laser light or light from a narrowband LED source, optionally polarized e.g. linearly polarized. An optical path between the objective lens and coherent light source may include a beam splitter to separate the returned reflected and scattered light from the incident illuminating light; in other implementations these two light paths are at different spatial positions with respect to the optical axis. The imaging device may comprise a 1D or 2D image sensor, e.g. an EMCCD (Electron Multiplying Charge Coupled Device) sensor or a fast CMOS camera. An optical element such as a lens or mirror may focus returned reflected and scattered light onto the image sensor.

The processor may comprise e.g. a general purpose computer system, mobile device, or digital signal processor under stored program control. The stored program may be provided on one or more non-transitory physical data carriers such as programmed memory, and may comprise source, object or executable code in a conventional programming language, or code for a hardware description language. Code to implement the system may be distributed between a plurality of coupled components in communication with one another.

The particle detection region may comprise an imaging region of a microfluidic channel or chamber. The interface which generates the reflected light may be an inner boundary of such a channel or chamber i.e. an interface with the fluid e.g. liquid, although in principle it could be an exterior boundary. The interface is typically flat, but in principle may be curved. In some other implementations the interface is defined by a physical surface of a transparent support, e.g. a glass coverslip, which bears a droplet of the liquid, and the particle detection region is above the physical surface of the transparent support.

If the fluid is a liquid flowing in a microchannel it may have a generally flat flow profile across a width of the channel; this may be achieved by driving flow of the liquid by using electro-osmosis. The liquid may comprise or consist essentially of water. Prior to interrogation using the interferometric scattering optical microscope system the liquid may be been filtered, separated, or otherwise treated to enhance a relative proportion of a target particle or reduce the presence of unwanted particles.

Other features of the interferometric scattering optical microscope system may correspond to those of the previously described method, i.e. the system may include sub-systems/devices to implement these features.

The particles may comprise molecules or molecular complexes, such as biological molecules/complexes, e.g. proteins, protein complexes, or antibodies. More generally the particles may have a maximum dimension which is less than a wavelength of the coherent light, or less than half this wavelength. Such particles may include metallic or other nanoparticles, colloid particles, polymer particles, viruses, exosomes and other extra-cellular vesicles, proteins, and bio-particles in general. The particles may be non-fluorescent particles i.e. label-free. In implementations the method and system may be used to detect and characterize from one to thousands or millions of particles.

### DRAWINGS

These and other aspects of the system will now be further described by way of example only, with reference to the accompanying figures, in which:

FIG. 1 shows an iSCAT system.

FIGS. 2a-2g show a process for determining a property of a particle from a succession of interference images, and illustrations of steps in the process.

FIG. 3 shows an example geometry for the system of FIG. 1.

FIGS. 4a and 4b show a set of curves of basis functions, and an example best fit selection.

In the figures like elements are indicated by like reference numerals.

### DESCRIPTION

This specification describes techniques for characterizing particles using correlations between images captured using interferometric scattering optical microscopy (iSCAT). The techniques may be used, for example, to detect and size proteins in aqueous solution, and to determine their concentration. The proteins do not need to be labelled, and single particles as well as large concentrations can be detected.

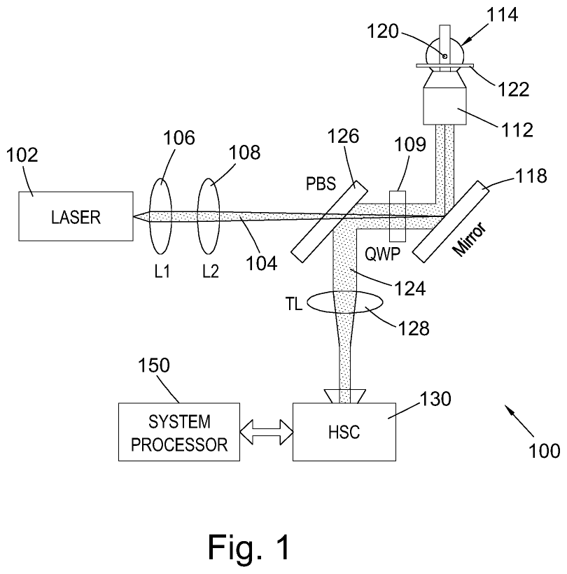

FIG. 1 shows an example iSCAT system 100. A continuous wave laser 102 provides a beam 104 of coherent light e.g. in the visible region of the spectrum, for illuminating one or more particles 120 to be characterized as described later. This beam is collimated by a first lens 106 (if not already collimated), and focused by a second lens 108 onto the back focal plane of a microscope objective lens 112, in the example via a (polarizing) beam splitter 126 and mirror 118.

The objective lens 112, e.g. an oil immersion objective, may be adjusted to provide generally uniform illumination in a detection region 114. The objective lens 112 may be an oil immersion objective, that is a region between the objective lens and the interface may be filled with index matched oil to reduce the intensity of oil-glass reflections and hence reduce the number of interfaces seen by the laser illumination.

In some implementations the detection region 114 may be defined by upper and lower surfaces of a chamber or channel (not shown), fabricated e.g. from glass or polymer containing a solution including the one or more particles 120. A channel/channel may be used to contain/flow the solution through the detection region; in other implementations the solution may be contained on a surface by surface tension with no chamber used.

Part of the laser illumination is reflected from an optical interface 122, e.g. a transparent support such as a cover slip or a boundary of the channel/chamber, and part is transmitted to be scattered by the particle(s) 120. The reflected light and the scattered light are captured by objective lens 112, passed back along the optical path of the illumination, directed into a separate path 124 by the beam splitter 126, and imaged. As illustrated the reflected and scattered light are focused onto an image sensor 130, e.g. a high speed camera, by imaging optics 128 such as a tube lens. The image sensor 130 may be, for example, a CMOS image sensor or an EMCCD image sensor; it may have a frame rate sufficient to capture and track movement of an imaged particle. The image sensor captures interference between the reflected and scattered light. Merely by way of example, a camera for the system may have one or more of: a field of view of around 10 μm or greater; a similar depth of field; and a pixel size of less than λ/2.

A focal plane of the objective lens 112 may be located below the optical interface 122, confining the particle(s) to a region above the focal plane. Alternatively the focal plane may be located above the optical interface 122, in which case particle(s) in a region between the focal plane and the optical interface may be characterized; this region may also extend above the focal plane. The focal plane of the objective lens 112 may be viewed, conceptually, as representing a location of the image sensor.

The iSCAT system captures images of the interference between the scattered light and reference light. In the above example the reference light comprises the reflected light generated by reflection from the optical interface 122, but reference light may be provided in other ways e.g. by splitting the beam 104 to generate a reference beam.

In some implementations the source of coherent light is linearly or circularly polarized. For example in the illustrated example the optical path from the laser to the objective lens 112 includes a quarter wave plate 109 that converts linearly polarized light from the laser into circularly polarized light (and vice-versa on the return path).

In some implementations the particle(s) 120 may be illuminated at an oblique angle, e.g. by displacing an axis of the illuminating laser beam away from an optical axis of the objective lens 112. This facilitates separating the interference (i.e. signal) from the directly reflected light (a source of noise), e.g. with a spatial filter.

In some implementations the laser 102 is a laser diode. The limited coherence length of a laser diode can reduce unwanted coherent reflections within the system. However the coherence length should be at least twice a distance from the particle to the interface. A wavelength of the laser may be in the visible; shorter wavelengths are scattered more but a sensitivity of the image sensor and transmission of the optics may reduce at shorter wavelengths.

The iSCAT system of FIG. 1 includes a system processor 150, configured to interface to the image sensor 130 to capture a succession of images of the interference between the scattered light and the reference light. The processor processes these images to determine image correlation values, as described later. The processor then characterizes the particle(s) from an observed decorrelation over time defined by the image correlation values. The processor may be configured to perform these tasks by suitable stored program code. In general the processor may include a user interface for the system e.g. for displaying results; and/or an external interface such as network connection for communicating or storing data from the system.

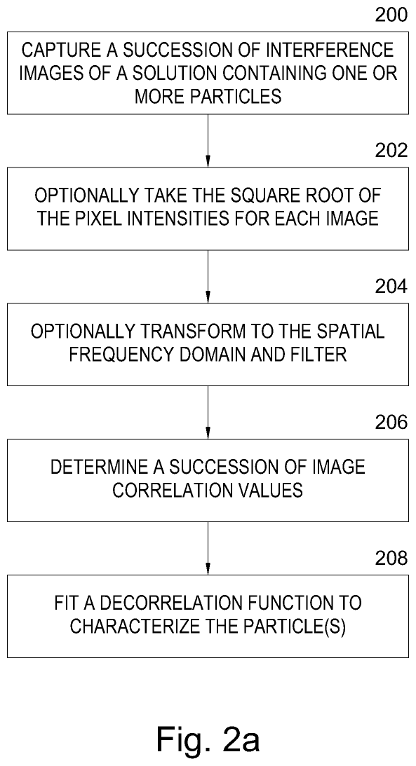

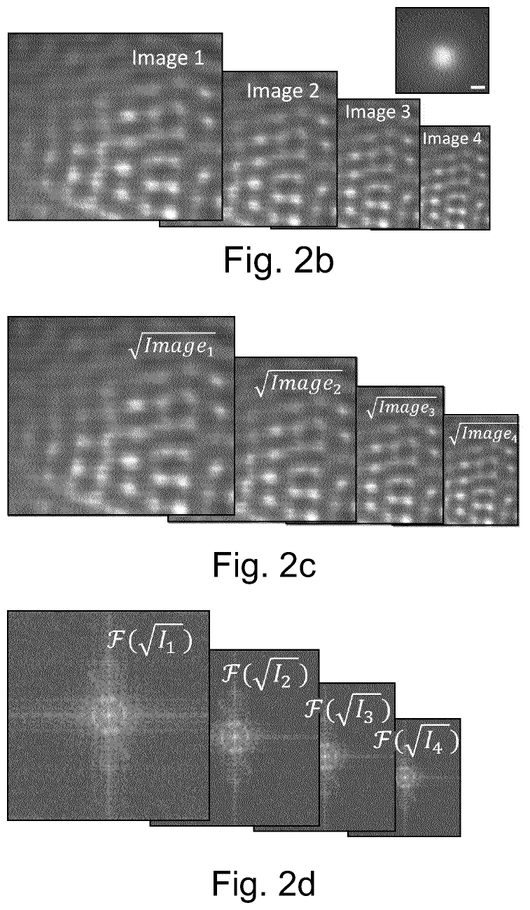

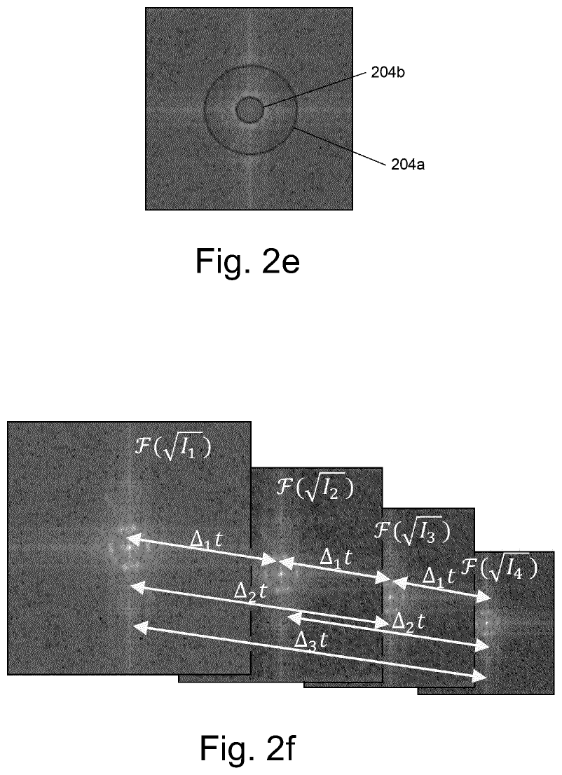

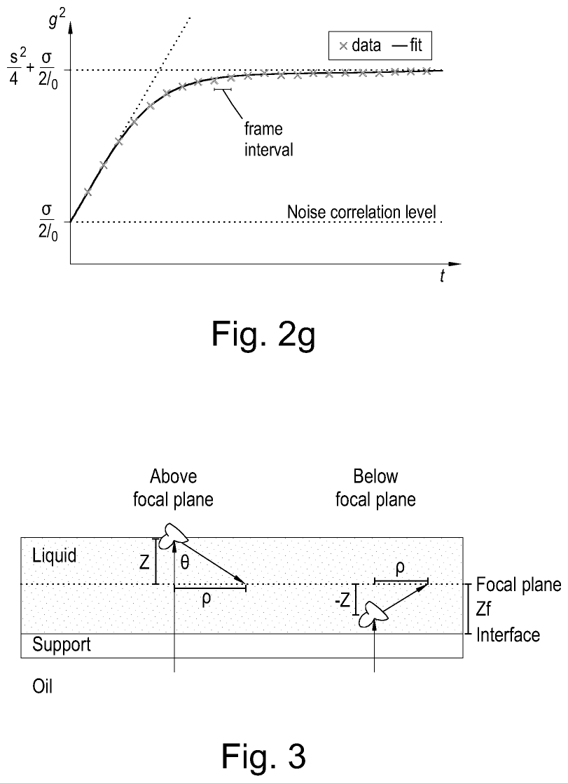

FIG. 2a shows a process for determining a property of a particle from a succession of interference images.

At step 200 the process captures a succession of interference images of a solution containing one or more particles to be characterized; each image may be termed an iSCAT signal. FIG. 2b shows an example of such images. Although FIG. 2b shows an interference pattern typically this is not clearly visible in a recorded image, which is dominated by the reflected intensity as shown by the inset example, an interference pattern only becoming visible when two frames are compared.

The images may be captured at a frame rate sufficient that, on average, a particle does not diffuse more than

$$\frac{λ}{4}$$

in the z-direction between successive frames, where λ is a wavelength of the illumination and the z-direction is along the optical axis of the objective lens 112. This can facilitate tracking the (de)correlation between frames. For example assuming a textbook diffusion equation a minimum frame rate may be given by fₘᵢₙᵢₘᵤₘ=2⁵D/λ² where D is a diffusion coefficient for the particle(s) (in m²/s).

At step 202 the process optionally takes a square root of each image, for example by taking a square root of the intensity value of each image pixel. This can facilitate determining a level of the scattering signal (intensity), which in turn facilitates estimating properties dependent upon the scattering signal such as particle size, number, or molecular weight. FIG. 2c shows an example of the result.

Taking the square root separates reflected (r) and scattered (s) intensity contributions to the iSCAT signal I=I₀(|r|²+|r∥s|cos ϕ) where ϕ is an interference phase given by a path difference between the reference (reflected) light and the scattered light at a focal plane of the image sensor and I₀ is the illumination intensity. A Taylor series expansion of √I separates the reflected and scattered contributions,

$$\sqrt{I} \approx \sqrt{{I}_{0}} ( \vert r \vert + \frac{\vert s ‖ cos ϕ}{2} ) .$$

This also reduces the shot noise variance of the iSCAT signal by a factor of 4. That is, for an iSCAT signal I and a normalised noise variance σₙ² the shot noise variance of the iSCAT signal σ_{I}²=Iσₙ²≈I₀|r|²σₙ² and the noise variance of the square rooted signal √I is σₙ²/4.

At step 204 the interference images may optionally be transformed to the spatial frequency domain, as shown in FIGS. 2d and 2e, e.g. by applying a (fast) Fourier transform to the images. This facilitates filtering to reduce noise. For example in the spatial frequency domain the interference signal is within a scattering circle e.g. of radius n/λ (where n is the refractive index of the fluid e.g. water in which the particle(s) are suspended), circle 204a in FIG. 2e. The part of the image outside the scattering circle can be removed to reduce the shot noise. A region 204b of a residual spot from the laser reflection may also be removed. The filtered images may be converted back into the spatial domain, or subsequent processing may continue in the frequency domain.

At step 206 the process determines a succession of image correlation values e.g. from the captured image frames, or from their square roots, or from the transformed images in the spatial frequency domain. For example one way a correlation value may be determined, for two space- or frequency-domain images separated in time by Δt, is by determining a difference between the corresponding pixel values of each image and summing the result. There are many other ways of determining a measure of correlation between two images.

In some implementations the image correlation values are determined for successively increasing time intervals to obtain the succession of image correlation values. For example, as illustrated in FIG. 2f, if the interval between two captured images is Δ_{frame}t, the time intervals may be Δ₁t=Δ_{frame}t, Δ₂t=2Δ_{frame}t, Δ₃t=3Δ_{frame}t and so forth. A correlation value for a time interval Δt may be determined by averaging over pairs of frames separated by Δt. Correlation values for larger time intervals may be less precise because there are fewer pairs of frames over which to average.

Then, at step 208, a decorrelation function is fitted to the succession of image correlation values to determine one or more properties of the particle(s). More particularly the decorrelation time depends on the diffusion coefficient of the particle(s), from which particle size, specifically hydrodynamic radius, can be determined.

In some implementations the decorrelation function may be fitted by fitting the succession of image correlation values to an equation describing the decorrelation. In some implementations the decorrelation function may be fitted by numerically calculating a set of basis functions, that is one or more functions using which the actual decorrelation may be modelled, and identifying one or a combination of the basis functions which best match the succession of image correlation values. Examples of both techniques are described later. The form of the basis functions may depend on the configuration of the iSCAT system and in principle could be determined by a system calibration.

The scattering signal also depends on the particle size, more particularly volume, and this in turn allows a weight or molecular weight to be estimated from an assumed particle or protein density. Also or instead a scale linking scattering signal to particle property e.g. molecular weight may be determined by calibration. The scattering signal may be determined by fitting the decorrelation function or more directly e.g. by integrating signal intensity over the scattering circle in the spatial frequency domain.

In an iSCAT system shot noise of the reflected light, more generally reference light, is a dominant source of noise. However the iSCAT signal depends on the reflected light intensity and thus naively increasing the image sensor exposure time does not improve the signal to noise ratio. When correlating two iSCAT images the noise signal is substantially the same no matter what the elapsed time between the images but the mean correlation increases as the elapsed time reduces. This recognition underlies the improved performance of iSCAT when the interference signal is used for determining a decorrelation signal from which to infer a property of the subject particle(s).

In general the correlation, g², between two images (I, \sqrt{I}, or frequency domain) may be defined as the normalized time average of the squared signal difference. For example in one implementation a (de)correlation between two square root images separated in time by Δt is defined as

$${g}^{2} ≡ \frac{{〈 {( Δ \sqrt{I} )}^{2} 〉}_{T}}{{( \sqrt{{I}_{0}} )}^{2}}$$

where [symbol] _{T} denotes averaging over time and Δ\sqrt{I} denotes a difference between the two images. Then in this example the (de)correlation between the square rooted iSCAT interference images is given by the decorrelation function

$${g}^{2} = \frac{{\vert s \vert}^{2}}{4} ( 1 - exp ( - \frac{Δ t}{τ} ) ) + \frac{{σ}_{n}^{2}}{2 {I}_{0}}$$

where a characteristic decorrelation time τ is defined as τ=(q²D)⁻¹ where

$$q = \frac{2 π}{λ} \sqrt{4 - {( 1 - \frac{Z}{\sqrt{{ρ}^{2} + {Z}^{2}}} )}^{2}}$$

and σₙ²/2I₀ represents a noise variance of the correlation signal. Here Z denotes a distance of the particle from the focal plane of the objective lens along the z-direction, and p denotes a distance of the particle from the optical axis of the objective lens perpendicular to the z-direction.

When averaging over n frames the noise variance reduces to

$$( \sqrt{2} / n ) \frac{{σ}_{n}^{2}}{2 {I}_{0}}$$

which depends linearly on image sensor exposure time (∝I₀) and on the square root of the number of frames. Thus noise can be reduced if image frames are combined or integrated then correlated, provided that the integration time is less than the correlation time τ (the signal to noise ratio maximum is for a single frame exposure time of less than half the correlation time).

FIG. 2g shows a curve of g² against time t for this example, conceptually illustrating fitting the decorrelation function to the correlation values. The correlation values may be fitted to the curve by calculating the correlation, g², from the correlation values for the succession of time intervals Δ₁t, Δ₂t, Δ₃t, and so forth. Values of the correlation calculated from the data i.e. from the captured iSCAT images, are indicated by crosses.

The curve of FIG. 2g tends to a value determined by s²/4 plus a noise level for the correlation σ/2I₀, as Δt increases. The noise level may be disregarded or it may be included as a constant term when fitting the decorrelation curve.

The scattering intensity s²/4, optionally with the noise level (at Δt=0) subtracted, depends on the size (volume) of the particle(s) as the scattering cross-section of a single particle is given by

$${σ}_{scatter} = \frac{8}{3} {π}^{2} {\vert α \vert}^{2} {λ}^{- 4} where α = 3 {ϵ}_{m} V ( \frac{{ϵ}_{p} - {ϵ}_{m}}{{ϵ}_{p} + 2 {ϵ}_{m}} ) ,$$

ϵₚ is the permittivity of the particle, ϵₘ is the permittivity of the medium (solution) and V is the particle volume. For a particular particle type e.g. a protein, a particle density and permittivity may be assumed. The particle volume then allows a measure of the total particle “weight”, and an estimate of a particle molecular weight if the number of particles is known. Alternatively a number or concentration of the particles may be estimated if the particle molecular weight (and permittivity) is known.

In another approach the scattering intensity s²/4 may be calibrated using known numbers of particles of different molecular weights to establish a (linear) calibration curve. This can then be used to estimate the molecular weight or number/concentration of particles in a solution to be characterized by the system.

FIG. 3 shows an example geometry for the system in which the focal plane of the objective lens is above the interface, in which case the particle may be above or below the focal plane. Referring again to the decorrelation function, for Z<0 i.e. when the particle is below the focal plane of the objective lens, i.e. the focal plane is above the interface 122, the value of q has only a weak dependence on Z. That is, where the particle is on the way to the focal plane does not much affect the path length of light scattered by the particle. However for Z>0 i.e. when the particle is above the focal plane of the objective lens, e.g. the focal plane is at or below the interface 122, the value of q depends strongly on Z, inverting the interference pattern if Z changes by a quarter wavelength. The initial slope of the curve of FIG. 2g depends on the speed of decorrelation. For Z>0 the decorrelation tends to be faster (greater slope) and less dependent on Z; for Z<0 the decorrelation is slower (reduced slope) and more dependent on Z.

In some implementations a value for the characteristic decorrelation time τ, and hence for the diffusion coefficient D, may be found by fitting the decorrelation function to the data i.e. to the correlation values. In one approach this involves calculating a set of curves of the type shown in FIG. 2g, and then selecting the curve or curves which best fits the data. The curves may be referred to as basis functions. Optionally a weighted combination of two or more basis functions may be fitted to the data, and the diffusion coefficient D may then be determined from a corresponding weighted combination of the values of D used to generate the basis functions. Optionally an effective or hydrodynamic size of the particle may be determined e.g. from the Stokes-Einstein equation which defines that D is inversely proportional to the hydrodynamic radius.

In some implementations the dependence on Z (and ρ) is integrated out, especially where Z>0. Physically this corresponds to an assumption that multiple particles are present with a distribution of values of Z (and ρ), and/or to integration over a time period over which the particle(s) move in Z. For example the integration may be over a time period sufficient to allow a particle to diffuse in Z a distance equal to the depth of field of the objective lens; or to diffuse in Z at least half the distance between the interface and the focal plane.

For example, in some implementations a basis function is given by:

$$B ( Δ t ) ≡ {\int }_{Zf}^{∞} dZ {\int }_{0}^{{ρ}_{max}} ρ d ρ ( {\vert {t}^{s} ( θ ) \vert}^{2} + {\vert {t}^{p} ( θ ) \vert}^{2} {cos}^{2} ( θ ) ) \frac{cos ( θ )}{{R}^{2} ( θ )} ( 1 - exp ( - \frac{Δ t}{τ ( Z , Σ )} ) )$$

where Zf defines a location of the interface 122, a negative value indicating that the interface is below the focal plane (i.e. nearer to the illuminating source than the focal plane), ρₘₐₓ is a value which may be chosen e.g. dependent on the horizontal field of view of the objective lens, and θ is defined by ρ and Z (as shown in FIG. 3). The transmission coefficient for s- and p-polarised light are is and t^{s} and t^{p} respectively (the p-polarised light is seen at an angle from the detection point and thus the intensity decreases relative to the detection angle θ as cos² (θ)), and because in this example the scattered light passes through the (transparent) support before detection Fresnel transmission coefficients R(⋅) are applied

$$( [ \frac{{n}_{1} cos {θ}_{1}}{{n}_{2} cos {θ}_{2}} ] {t}^{2} ) .$$

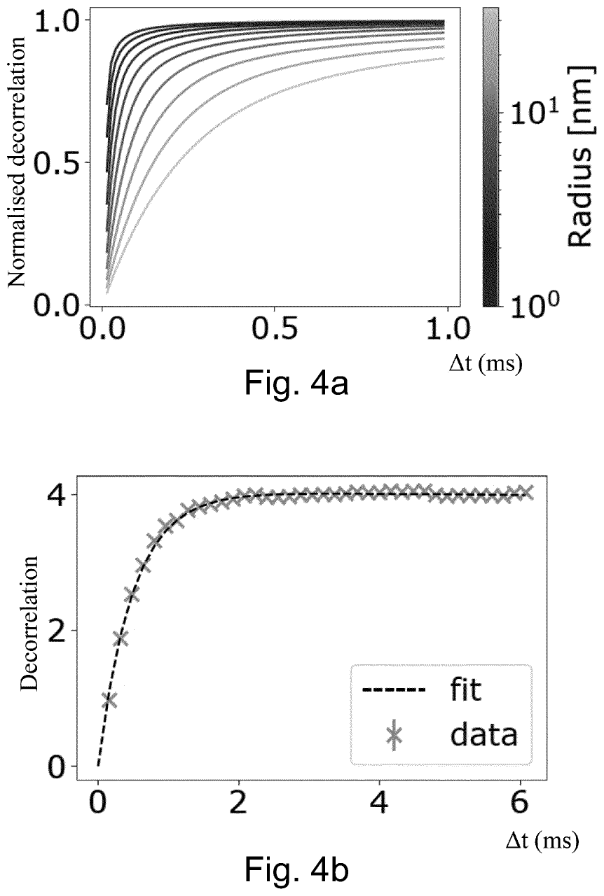

FIG. 4a illustrates a set of curves of basis functions calculated in this manner, for a range of different particle radii, and FIG. 4b illustrates an example best fit selection from amongst the basis functions which allows a radius for the particle to be determined. Optionally when fitting a basis function an offset corresponding to noise variance may be added as previously described; optionally a further term may be added to account for extraneous longer time correlations within the system e.g. a term linearly dependent on Δt.

Not shown in FIG. 4a, the basis function curves also depend on the position of the interface with respect to the focal plane i.e. on Zf. For example, if the interface is above the focal plane the decorrelation is faster than if the interface is below the focal plane. In addition the integrated scattering intensity drops off when the particle is above the focal plane by greater than a field of view of the objective lens.

The basis function curves cease to be significantly dependent on Zf when the interface 122 is around 20 μm or more below the focal plane i.e. Zf≤−20 μm. In this regime, i.e. where the focal plane of the objective lens lies within the bulk of the fluid, the scattering intensity is also a reliable metric. An added benefit is that the interface 122 may not be in focus, reducing unwanted scattering from this surface.

Some implementations of the system may be used to characterize particles in flow, by separating a component of the signal due to the flow, most easily done by processing in the spatial frequency domain.

In the Fourier domain a translation is equivalent to a phase difference and thus for a translation (Δx, Δy) the Fourier transform of fₙ₊₁(x, y)=fₙ(x+Δx,y+Δy) is Fₙ₊₁(ϵ, η)=exp(iθ)Fₙ(ϵ, η) where θ≡2π(ϵΔx+ηΔy). As before taking the square root of the iSCAT signal separates the reflected and scattered intensity and the Fourier transform of frame n can be written as F{\sqrt{I}ₙ}≈Fᵣ+F_{s,n}. The Fourier transform of frame n+1, F_{s,n+1} is related to F_{s,n} by a difference in the scattering pattern δF_{s,n} arising from diffusion of the particle, and by a translation, F_{s,n+1}=exp (iθ)F_{s,n}+δF_{s,n+1}. The difference used to compute the interferometric iSCAT signal is therefore

Δₙ₊₁=F_{s,n+1}−F_{s,n}=(exp (iθ)−1)F_{s,n}+δF_{s,n+1}

and a similar forward calculation gives

Δₙ=F_{s,n}−F_{s,n-1}=(exp (−iθ)((exp (iθ)−1F_{s,n}+δF_{s,n}).

where θ=0 corresponds to no flow. The ratio Δₙ₊₁/Δₙ may be taken as constant between pairs of frames to detect the offset by assuming δF to be small so that δₙ₊₁/Δₙ≈exp(iθ). This can be used to calculate a value for θ, and hence the translation between frames and flow rate. Further, when θ is known, a difference ΔΔₙ dependent upon δF terms (which can be evaluated more easily than F) can be determined as follows:

ΔΔₙ=Δₙ₊₁−exp (iθ)Δₙ=δF_{s,n+1}−δF_{s,n}

Since ΔΔₙ is a sum of Gaussian random variables with the same variance, ΔΔₙ may be used as a correlation value as previously described, the contribution due to the flow having been removed.

Many alternatives will occur to the skilled person. The invention is not limited to the described embodiments and encompasses modifications apparent to those skilled in the art lying within the scope of the claims appended hereto.

1. A method of characterizing one or more particles in a fluid using interferometric scattering optical microscopy, comprising:
illuminating a region of a fluid with illuminating light using an objective lens to generate scattered light scattered by one or more particles in the fluid;
providing reference light, wherein the reference light and illuminating light are coherent with one another;
capturing the reference light and the scattered light using the objective lens;
providing the reference light and the scattered light to an imaging device, such that the reference light and the scattered light interfere at the imaging device;
capturing a succession of images of the interference;
processing the succession of images of the interference to determine a succession of image correlation values, wherein the succession of image correlation values defines a decorrelation over time of the captured images of the interference; and
determining a property of the one or more particles from the succession of image correlation values defining the decorrelation over time.

2. A method as claimed in claim 1 wherein providing the reference light comprises illuminating the region of the fluid through an interface such that light is reflected from the interface to provide the reference light.

3. A method as claimed in claim 1 wherein determining a property of the one or more particles comprises determining a size of the one or more particles by fitting a decorrelation function to the succession of image correlation values, wherein the decorrelation function is dependent upon a diffusion coefficient for the one or more particles in the fluid.

4. A method as claimed in claim 3 further comprising locating a focal plane of the objective lens above the interface, and wherein the decorrelation function is substantially independent of a distance of the one or more particles from the focal plane in a direction along an optical axis of the objective lens.

5. A method as claimed in claim 3 further comprising locating a focal plane of the objective lens adjacent to or below the interface, and wherein the decorrelation function comprises an average over at least a region beyond the interface.

6. A method as claimed in claim 3 wherein the succession of images spans a time period sufficient to allow the one or more particles to, on average, diffuse a distance of at least half that between the interface and the focal plane or diffuse a distance equal to a depth of field of the objective lens.

7. A method as claimed in claim 3 wherein fitting the decorrelation function comprises identifying which of one or more basis functions best fits the succession of image correlation values, wherein each of the basis functions is defined by the size of the one or more particles.

8. A method as claimed in claim 7 wherein each of the basis functions is integrated over the region between the interface and the focal plane.

9. A method as claimed in claim 3 wherein the decorrelation function is also dependent upon an intensity of the scattered light, and wherein determining a property of the one or more particles further comprises determining a concentration or count and/or molecular weight of the one or more particles in the fluid by fitting the decorrelation function.

10. A method as claimed in claim 3 wherein fitting the decorrelation function to the succession of image correlation values includes fitting an offset representing a noise level.

11. A method as claimed in claim 1 comprising capturing the succession of images of the interference with the imaging device at a frame rate greater than a threshold frame rate, wherein the threshold frame rate is such that, on average, one of the particles does not diffuse in a z-direction by more than λ/4 between captured images, where λ is a wavelength of the illuminating light and the z-direction is defined by an optical axis of the objective lens.

12. A method as claimed in claim 1 wherein processing the succession of images of the interference comprises combining images of the interference before determining the succession of image correlation values, wherein the combining comprises combining images separated in time by no more than a characteristic time of the decorrelation.

13. A method as claimed in claim 1 wherein processing the succession of images of the interference comprises determining a square root of an intensity of the images of the interference before determining the succession of image correlation values.

14. A method as claimed in claim 1 wherein processing the succession of images of the interference comprises performing a space-frequency transform to transform each of the images to a frequency space image before determining the succession of image correlation values.

15. A method as claimed in claim 14 further comprising spatially filtering the frequency space image to attenuate spatial frequencies greater than a maximum expected spatial frequency.

16. A method as claimed in claim 14 further comprising estimating a flow rate measure of the fluid from a succession of the frequency space images, and using the flow rate measure to compensate for a flow of the fluid.

17. A method as claimed in claim 16 wherein estimating the flow rate measure comprises determining a ratio of two of the frequency space images, wherein the ratio defines a phase angle, and wherein compensating for the flow of the fluid comprises adjusting a phase angle of one or more of the frequency space images.

18. An interferometric scattering optical microscope system for characterizing one or more particles in a fluid, the system comprising: a particle detection region wherein, in use, the particle detection region comprises one or more particles in a fluid;
a source of illuminating light;
a source of reference light, wherein the reference light and illuminating light are coherent with one another;
an objective lens to direct the illuminating light to illuminate the particle detection region through the interface such that the illuminating light is scattered by the one or more particles,
wherein the objective lens is configured to capture the reference light and the scattered light;
an imaging device;
an optical system to provide the reference light and the scattered light to the imaging device such that the reference light and the scattered light interfere at the imaging device; and
a processor configured to:
capture a succession of images of the interference
process the succession of images of the interference to determine a succession of image correlation values, wherein the succession of image correlation values defines a decorrelation over time of the captured images of the interference; and
determine a property of the one or more particles from the succession of image correlation values defining the decorrelation over time.

19. An interferometric scattering optical microscope system as claimed in claim 18 wherein the particle detection region has a boundary defined by an interface; wherein the source of reference light comprises the interface; and wherein the objective lens is configured to direct the illuminating light to illuminate the particle detection region through the interface such that the illuminating light is reflected from the interface to generate the reference light.
